(19) United States
(12) Patent Application Publication
(10) Pub. No.: US 2026/0008140 A1
(43) Pub. Date: Jan. 8, 2026

(54) PUMP INSTALLATION APPARATUS, PUMP INSTALLATION METHOD, PUMP REMOVING METHOD

(71) Applicant: EBARA CORPORATION, Tokyo (JP)

(72) Inventors: Shuichiro HONDA, Tokyo (JP); Tetsuji KASATANI, Tokyo (JP); Hayato IKEDA, Tokyo (JP); Kei WATAJI, Tokyo (JP); Hyuga KIKUCHI, Tokyo (JP); Mitsutaka IWAMI, Tokyo (JP)

(21) Appl. No.: 18/858,782

(22) PCT Filed: Apr. 20, 2023
(86) PCT No.: PCT/JP2023/015826

§ 371 Date: Jul. 25, 2025

(30) Foreign Application Priority Data
Apr. 28, 2022 (JP) 2022-074475

(51) Int. Cl. B23P 19/04; B66C 19/00

(52) U.S. Cl. CPC B23P 19/04; B66C 19/00

(57) ABSTRACT

The pump installation apparatus includes a working chamber forming a closed working space, an actuator-driven door covering an upper opening of a pump column, a suspension cable for suspending a submersible pump in the pump column, and a crane for raising and lowering the suspension cable. An upper opening of the pump column, the actuator-driven door, and the crane are arranged in the working space.

### TECHNICAL FIELD

The present invention relates to a pump installation apparatus for installing a submersible pump for pressurizing liquefied gas, such as liquefied ammonia, liquefied natural gas (LNG), liquid hydrogen, etc., in a pump column and removing the submersible pump from the pump column. The present invention further relates to a method of installing a submersible pump in a pump column using the pump installation apparatus and a method of removing the submersible pump from the pump column using the pump installation apparatus.

### BACKGROUND ART

Natural gas is widely used for thermal power generation and used as a raw material for chemicals. Furthermore, ammonia and hydrogen are expected to be energies that do not generate carbon dioxide that causes global warming. Applications of hydrogen as an energy include fuel cell and turbine power generation. Natural gas, ammonia, and hydrogen are in a gaseous state at normal temperature, and therefore natural gas, ammonia, and hydrogen are cooled and liquefied for their storage and transportation. Liquefied gas, such as liquefied natural gas (LNG), liquefied ammonia, and liquid hydrogen, is temporarily stored in a liquefied-gas storage tank and then delivered to a power plant, factory, or the like by a pump.

FIG. 19 is a schematic diagram showing a conventional example of a liquefied-gas storage tank in which liquefied gas is stored and a pump for pumping up the liquefied gas. A pump 500 is installed in a vertical pump column 505 disposed in a liquefied-gas storage tank 501. An upper opening of the pump column 505 is closed by a top cover 510. The interior of the pump column 505 is filled with the liquefied gas, and the entire pump 500 is immersed in the liquefied gas. Therefore, the pump 500 is a submersible pump that can operate in the liquefied gas.

When the pump 500 is operated, the liquefied gas in the liquefied-gas storage tank 501 is sucked into the pump column 505, ascends the pump column 505, and is discharged from the pump column 505 through a liquefied-gas discharge port 509. The pump column 505 has a purge-gas introduction port 512. This purge-gas introduction port 512 is closed when the pump 500 is in operation.

FIG. 20 is a diagram for explaining an operation of carrying the pump 500 into the pump column 505 and an operation of pulling up the pump 500 from the pump column 505. When the pump 500 is to be installed in the pump column 505 and when the pump 500 is to be removed from the pump column 505 for the purpose of maintenance, the top cover 510 is removed and a cable 508 is coupled to a hoist 513. The pump 500 is suspended from the cable 508 and is raised or lowered within the pump column 505 by the hoist 513.

The liquefied gas remaining in the pump column 505 is gasified to form boil-off gas (BOG). During the operations of carrying in the pump 500 and pulling up the pump 500, a purge gas is introduced into the pump column 505 through the purge-gas introduction port 512 to prevent the boil-off gas (BOG) from being released into the atmosphere. In addition, the purge gas serves to prevent air from entering the pump column 505. An inert gas, such as N₂ gas or He gas, is used as the purge gas.

### CITATION LIST

### Patent Literature

Patent document 1: Japanese Patent No. 3197645
Patent document 2: Japanese Patent No. 3198248
Patent document 3: Japanese Patent No. 3472379

### SUMMARY OF INVENTION

### Technical Problem

However, the upper opening of the pump column 505 is larger than the width of the pump 500, and therefore a large amount of the purge gas is required in order to prevent air from entering the pump column 505 while preventing the boil-off gas (BOG) from being discharged outside the pump column 505. In particular, He gas is expensive, which increases costs of carrying in and pulling up the pump 500.

In addition, during the operations of carrying in and pulling up the pump 500, a working person may be exposed to the boil-off gas, and as a result, a safe working environment may not be ensured. In particular, when the cable 508 is pulled up from the pump column 505, the cable 508, which has been in contact with the liquefied gas, has an extremely low temperature, and handling of such cable 508 is dangerous.

Therefore, the present invention provides a pump installation apparatus that can reduce an amount of purge gas used to prevent boil-off gas (BOG) from being released from a pump column when a submersible pump is carried into and pulled up from the pump column, and can provide a safe working environment. The present invention further provides a method of installing a submersible pump in a pump column and a method of removing a submersible pump from a pump column using the pump installation apparatus.

### Solution to Problem

In an embodiment, there is provided a pump installation apparatus for installing a submersible pump in a pump column and removing the submersible pump from the pump column, the submersible pump being used to deliver liquefied gas, the pump installation apparatus comprising: a working chamber forming an enclosed working space therein; an actuator-driven door covering an upper opening of the pump column; a suspension cable configured to suspend the submersible pump in the pump column; and a crane configured to raise and lower the suspension cable, an upper opening of the pump column, the actuator-driven door, and the crane being disposed in the working space.

In an embodiment, the suspension cable comprises a plurality of split suspension cables and a plurality of coupling links configured to couple the plurality of split suspension cables, and the pump installation apparatus further comprises a link operating device configured to operate the plurality of coupling links to cause the plurality of coupling links to couple and separate the plurality of split suspension cables.

In an embodiment, the working chamber includes a purge-gas inlet port communicating with the working space, and a purge-gas supply line coupled to the purge-gas inlet port.

In an embodiment, the pump installation apparatus further comprises: a first electrical contact electrically coupled to an electric motor of the submersible pump; a second electrical contact fixed to the pump column and in contact with the first electrical contact; and a power cable electrically coupled to the second electrical contact.

In an embodiment, there is provided a method of installing a submersible pump in a pump column, the submersible pump being used to deliver liquefied gas, the method comprising: opening an actuator-driven door disposed within an enclosed working space formed by a working chamber, the actuator-driven door being coupled to an upper portion of the pump column; coupling a suspension cable to the submersible pump within the working space; and lowering the suspension cable and the submersible pump in the pump column by a crane disposed in the working space, an upper opening of the pump column being located in the working space.

In an embodiment, the suspension cable has a plurality of split suspension cables and a plurality of coupling links configured to couple the plurality of split suspension cables, and lowering the suspension cable and the submersible pump in the pump column comprises lowering the plurality of split suspension cables and the submersible pump in the pump column by the crane while operating the plurality of coupling links with a link operating device to couple the plurality of split suspension cables one by one.

In an embodiment, the method further comprises supplying a purge gas into the working space before the submersible pump is carried into the pump column to expose the submersible pump to the purge gas within the working space.

In an embodiment, the method further comprises bringing a first electrical contact, which is electrically coupled to an electric motor of the submersible pump, into contact with a second electrical contact fixed to the pump column when the suspension cable and the submersible pump are lowered in the pump column.

In an embodiment, there is provided a method of removing a submersible pump from a pump column, the submersible pump being used to deliver liquefied gas, the method comprising: opening an actuator-driven door located in an enclosed working space formed by a working chamber, the actuator-driven door being coupled to an upper portion of the pump column; raising a suspension cable and the submersible pump in the pump column by pulling up the suspension cable coupled to the submersible pump with a crane, the crane being disposed in the working space; separating the suspension cable from the submersible pump; and raising the submersible pump from the pump column into the working space by the crane, an upper opening of the pump column being located in the working space.

In an embodiment, the suspension cable has a plurality of split suspension cables and a plurality of coupling links configured to couple the plurality of split suspension cables, and raising the suspension cable and the submersible pump in the pump column comprises raising the plurality of split suspension cables and the submersible pump in the pump column with the crane while operating the plurality of coupling links with a link operating device to separate the plurality of split suspension cables one by one.

In an embodiment, the method further comprises supplying a purge gas into the working space after raising the submersible pump from the pump column into the working space to expose the submersible pump to the purge gas within the working space.

In an embodiment, the method further comprises separating a first electrical contact, which is electrically coupled to an electric motor of the submersible pump, from a second electrical contact fixed to the pump column when the suspension cable and the submersible pump are raised in the pump column.

### Advantageous Effects of Invention

According to the present invention, the submersible pump can be automatically installed in the pump column and can be pulled up from the pump column by the remote operation of the crane and the actuator-driven door from outside the working chamber. Therefore, the working person is not exposed to a dangerous atmosphere. In addition, since the upper opening of the pump column is located within the closed working space, boil-off gas (BOG) is not released into the atmosphere. As a result, an amount of the purge gas used to prevent the release of boil-off gas (BOG) into the atmosphere can be substantially zero. Furthermore, when the submersible pump is carried into the pump column, the working space is filled with a gas having the same components as the liquefied gas, thereby preventing entry of gas containing other components, such as air, into the pump column.

### BRIEF DESCRIPTION OF DRAWINGS

FIG. 1 is a diagram showing an embodiment of a pump system for delivering a liquefied gas;

FIG. 2A is a diagram showing a first electrical contact and a second electrical contact as viewed from a radial direction of a pump column;

FIG. 2B is a diagram showing the first electrical contact and the second electrical contact as viewed from the radial direction of the pump column;

FIG. 3 is a cross-sectional view showing an embodiment of a coupling link;

FIG. 4A is a diagram explaining a manner in which a first link mechanism is coupled to a second link mechanism by a link operating device;

FIG. 4B is a diagram explaining a manner in which the first link mechanism is coupled to the second link mechanism by the link operating device;

FIG. 5A is a diagram explaining a manner in which the first link mechanism is separated from the second link mechanism by the link operating device;

FIG. 5B is a diagram explaining a manner in which the first link mechanism is separated from the second link mechanism by the link operating device;

FIG. 6 is a top view showing one embodiment of a support plate;

FIG. 7 is a diagram showing a state before a suspension cable and a submersible pump are carried into the pump column;

FIG. 8 is a diagram explaining one embodiment of a method of installing the submersible pump in the pump column;

FIG. 9 is a diagram explaining one embodiment of the method of installing the submersible pump in the pump column;

FIG. 10 is a diagram explaining one embodiment of the method of installing the submersible pump in the pump column;

FIG. 11 is a diagram explaining one embodiment of the method of installing the submersible pump in the pump column;

FIG. 12 is a diagram explaining one embodiment of the method of installing the submersible pump in the pump column;

FIG. 13 is a diagram explaining one embodiment of the method of installing the submersible pump in the pump column;

FIG. 14 is a diagram explaining one embodiment of a method of removing the submersible pump from the pump column;

FIG. 15 is a diagram explaining one embodiment of the method of removing the submersible pump from the pump column;

FIG. 16 is a diagram explaining one embodiment of the method of removing the submersible pump from the pump column;

FIG. 17 is a diagram explaining one embodiment of the method of removing the submersible pump from the pump column;

FIG. 18 is a diagram explaining one embodiment of the method of removing the submersible pump from the pump column;

FIG. 19 is a schematic diagram showing a conventional example of a liquefied-gas storage tank in which liquefied gas is stored, and a pump for pumping up the liquefied gas; and

FIG. 20 is a diagram explaining an operation of carrying the pump into the pump column and an operation of raising the pump out of the pump column.

### DESCRIPTION OF EMBODIMENTS

Hereinafter, embodiments of the present invention will be described with reference to the drawings.

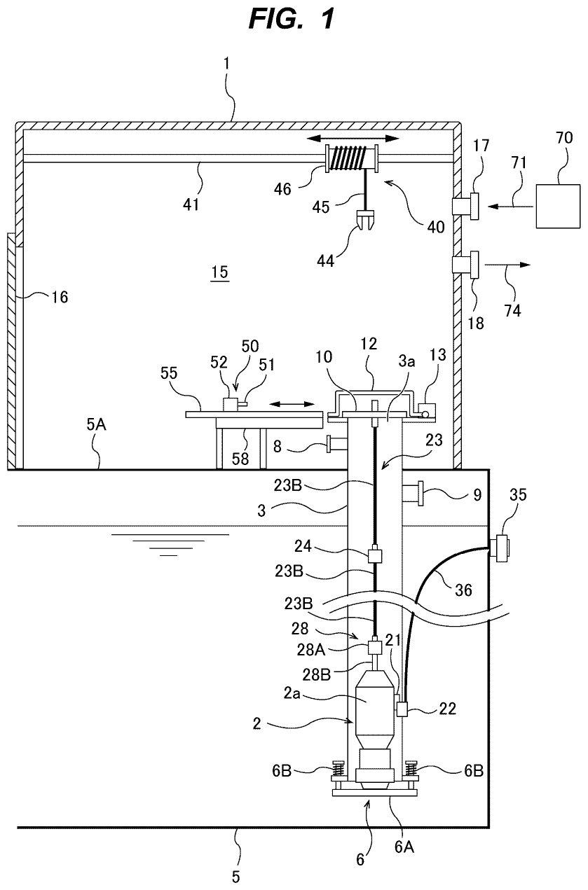

FIG. 1 is a diagram showing one embodiment of a pump system for delivering a liquefied gas. Examples of the liquefied gas that can be delivered by the pump system shown in FIG. 1 include liquefied ammonia, liquid hydrogen, liquid nitrogen, liquefied natural gas, liquefied ethylene gas, and liquefied petroleum gas.

As shown in FIG. 1, the pump system includes a submersible pump 2 configured to deliver the liquefied gas, a pump column 3 in which the submersible pump 2 is disposed, and a head plate 10 configured to close an upper opening of the pump column 3. The pump column 3 is installed in a liquefied-gas storage tank 5 in which the liquefied gas is stored. The pump column 3 is a hollow container extending vertically, and its upper portion protrudes upward from the liquefied-gas storage tank 5. The pump column 3 has a purge-gas introduction port 8 and a discharge port 9. The discharge port 9 is coupled to a transfer pipe (not shown) that extends from an interior to an exterior of the liquefied-gas storage tank 5.

A suction valve 6 is provided on a bottom of the pump column 3. The submersible pump 2 is installed on the suction valve 6 of the pump column 3. The suction valve 6 has a valve element 6A that covers a lower opening of the pump column 3, and a plurality of springs 6B that push the valve element 6A upward. When the submersible pump 2 is not placed on the valve element 6A, the valve element 6A is pressed against a lower end of the pump column 3 by the springs 6B, thereby closing the lower opening of the pump column 3. When the submersible pump 2 is placed on the valve element 6A, the valve element 6A moves downward against the force of the springs 6B due to the weight of the submersible pump 2, thereby opening the suction valve 6. The suction valve 6 may be an actuator-driven valve (e.g., an electric valve).

The head plate 10 is placed on an upper end of the pump column 3. The head plate 10 is covered with an actuator-driven door 12. A suspension cable 23 and a coupling structure 28 are suspended from the head plate 10. The suspension cable 23 extends vertically within the pump column 3. The suspension cable 23 has a plurality of split suspension cables 23B coupled by coupling links 24.

The coupling structure 28 is attached to the submersible pump 2. The coupling structure 28 is coupled to a lower end of the suspension cable 23. More specifically, the coupling structure 28 includes a link mechanism 28A coupled to the suspension cable 23, and a coupling member 28B connecting the link mechanism 28A and the submersible pump 2. The coupling member 28B may be a cable, a rod-shaped member, or the like. The link mechanism 28A has a width larger than that of the coupling member 28B.

An electric terminal 35 is attached to a side wall of the liquefied-gas storage tank 5. This electric terminal 35 is coupled to a power source (not shown). A first electrical contact 21 is electrically coupled to an electric motor 2a of the submersible pump 2 and is fixed to the submersible pump 2. A second electrical contact 22 in contact with the first electrical contact 21 is provided on the side wall of the pump column 3. A power cable 36 for supplying electric power to the electric motor 2a of the submersible pump 2 extends from the electric terminal 35 to the second electrical contact 22.

The first electrical contact 21 is fixed to an outer surface of the submersible pump 2 and protrudes radially outward from the outer surface of the submersible pump 2. The second electrical contact 22 is located radially outwardly of the submersible pump 2. The first electrical contact 21 is movable together with the submersible pump 2, while the position of the second electrical contact 22 is fixed. A portion of the second electrical contact 22 is disposed outside the pump column 3, and the entirety of the power cable 36 is disposed outside the pump column 3. The second electrical contact 22 extends through the side wall of the pump column 3. Thus, the second electrical contact 22 has an outer portion that is located outside the pump column 3 and an inner portion that is located inside the pump column 3. An end of the power cable 36 is coupled to the outer portion of the second electrical contact 22.

The first electrical contact 21 and the second electrical contact 22 are in contact with the liquefied gas, but the liquefied gas used in this embodiment has an electrical insulation property, so that no electric leakage occurs through the first electrical contact 21 and the second electrical contact 22.

Although not shown, in another embodiment, the second electrical contact 22 may be located entirely within the pump column 3, and the power cable 36 may extend through the side wall of the pump column 3 to the second electrical contact 22.

The first electrical contact 21 is movable together with the submersible pump 2 and is movable relative to the second electrical contact 22. The first electrical contact 21 can come into contact with the second electrical contact 22 when the submersible pump 2 is lowered in the pump column 3. When the submersible pump 2 is lowered to an operating position in the pump column 3 (the position of the submersible pump 2 shown in FIG. 1), the first electrical contact 21 comes into contact with the second electrical contact 22. This establishes an electrical connection between the first electrical contact 21 and the second electrical contact 22. Electric power is supplied to the electric motor 2a of the submersible pump 27 from the power cable 36 via the second electrical contact 22 and the first electrical contact 21, thereby operating the submersible pump 2.

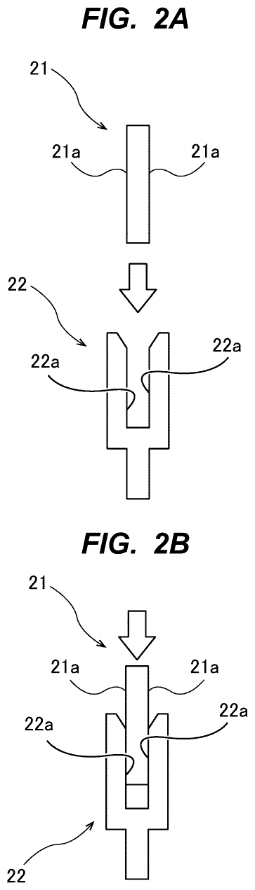

FIG. 2A is a view of the first electrical contact 21 and the second electrical contact 22 as viewed from a radial direction of the pump column 3. The first electrical contact 21 has first contact surfaces 21a extending along the longitudinal direction of the pump column 3. Similarly, the second electrical contact 22 has second contact surfaces 22a extending along the longitudinal direction of the pump column 3. In this embodiment, the first electrical contact 21 has a flat plate shape, and the second electrical contact 22 has a clamp shape that sandwiches the first electrical contact 21. In one embodiment, the second electrical contact 22 may have a flat plate shape, and the first electrical contact 21 may have a clamp shape that sandwiches the second electrical contact 22.

As shown in FIG. 2B, the first electrical contact 21 can be moved toward the second electrical contact 22 until the first contact surfaces 21a contact the second contact surfaces 22a. The first contact surfaces 21a and the second contact surfaces 22a are parallel to each other and extend in the longitudinal direction of the pump column 3. Therefore, the first electrical contact 21 and the second electrical contact 22 can move relative to each other in the longitudinal direction of the pump column 3, while the first electrical contact 21 and the second electrical contact 22 are in contact with each other.

Referring back to FIG. 1, when the submersible pump 2 is in operation, the liquefied gas in the liquefied-gas storage tank 5 is introduced into the pump column 3 through the suction valve 6, and the pump column 3 is filled with the liquefied gas. When the submersible pump 2 is in operation, the entire submersible pump 2 is immersed in the liquefied gas. Therefore, the submersible pump 2 is configured to be able to operate in the liquefied gas. The liquefied gas pressurized by the submersible pump 2 is delivered to the outside through the discharge port 9 and a transfer pipe (not shown). While the submersible pump 2 is in operation, the purge-gas introduction port 8 is closed by a valve (not shown).

Next, a pump installation apparatus for installing the submersible pump 2 in the pump column 3 and removing the submersible pump 2 from the pump column 3 will be described. The pump system includes the pump installation apparatus described below. The pump installation apparatus includes a working chamber 1 forming a closed working space 15 therein, the actuator-driven door 12 covering the upper opening 3a of the pump column 3, the suspension cable 23 for suspending the submersible pump 2 in the pump column 3, a crane 40 for raising and lowering the suspension cable 23, and the first electrical contact 21 and the second electrical contact 22. The upper opening 3a of the pump column 3, the actuator-driven door 12, and the crane 40 are arranged in the working space 15. The working chamber 1 has a working door 16 through which the submersible pump 2, the suspension cable 23, and other elements are carried into and removed out of the working space 15. This working door 16 is usually closed.

The working chamber 1 is fixed to an upper wall 5A of the liquefied-gas storage tank 5. The working chamber 1 includes a purge-gas inlet port 17 and a gas outlet port 18 that communicate with the working space 15. A purge-gas supply line 71 extending from a purge-gas supply source 70 is coupled to the purge-gas inlet port 17. A vacuum line 74 is coupled to the gas outlet port 18. The vacuum line 74 is coupled to a vacuum source (not shown), such as a vacuum pump. Examples of the purge-gas supply source 70 include a nitrogen-gas supply source, a helium-gas supply source, a hydrogen-gas supply source, or a combination thereof. In one embodiment, the purge-gas supply source 70 may include at least two of different types of purge-gas supply sources, which may be a nitrogen-gas supply source, a helium-gas supply source, and a hydrogen-gas supply source. In this case, multiple purge-gas supply sources may be selectively coupled to the purge-gas supply line 71.

The purge gas used is gas composed of component (or element) having a boiling point lower than or equal to the boiling point of the liquefied gas to be pumped up by the submersible pump 2. This is because of preventing the purge gas from being liquefied when the purge gas contacts the liquefied gas. Examples of purge gas include inert gas, such as nitrogen gas and helium gas. For example, when the liquefied gas to be pumped up by the submersible pump 2 is liquefied natural gas, nitrogen gas is used for the purge gas, since the nitrogen gas is composed of nitrogen having a boiling point (−196° C.) lower than the boiling point (−162° C.) of the liquefied natural gas. In another example, when the liquefied gas to be pumped up by the submersible pump 2 is liquid hydrogen, helium gas is used for the purge gas, since the helium gas is composed of helium having a boiling point (−269° C.) lower than the boiling point of hydrogen (−253° C.).

A part of the purge gas may contain a gas having the same component as that of the liquefied gas. If the purge-gas outlet port 18 is coupled to a gas treatment device, all of the purge gas may be gas of the same component as the liquefied gas. For example, if the liquefied gas is liquid hydrogen, a part or all of the purge gas may be hydrogen gas. In another example, if the liquefied gas is liquefied ammonia, a part or all of the purge gas may be ammonia gas.

The actuator-driven door 12 is coupled to the upper part of the pump column 3. The actuator-driven door 12 covers the upper opening 3a of the pump column 3 and the head plate 10 that closes the upper opening 3a. The actuator-driven door 12 includes an actuator 13, such as an electric motor or an air cylinder. The actuator-driven door 12 is configured to open and close in response to a command signal transmitted from outside the working chamber 1. During operation of the submersible pump 2, the actuator-driven door 12 is closed as shown in FIG. 1.

When the actuator-driven door 12 is closed, a sealed space is formed between the actuator-driven door 12 and the upper part of the pump column 3. The head plate 10 is located in this sealed space. The actuator-driven door 12 can prevent boil-off gas (BOG) that has passed through a minute gap between the head plate 10 and the upper part of the pump column 3 from leaking into the working space 15 of the working chamber 1.

The crane 40 is configured to be movable in the working space 15. More specifically, the crane 40 is movable on a support rail 41 arranged in the working space 15, as indicated by an arrow. The crane 40 can move between a position above the pump column 3 and a position away from the pump column 3. The crane 40 includes a gripping mechanism 44, a wire 45 for suspending the gripping mechanism 44, and a take-up device 46 for reeling out and reeling in the wire 45. The gripping mechanism 44 is configured to be capable of gripping the head plate 10, the suspension cable 23, the coupling link 24, the coupling structure 28, and other elements. Examples of the take-up device 46 include a hoist and a winch. The crane 40 is configured to operate upon receiving a command signal transmitted from outside the working chamber 1.

The suspension cable 23 includes a plurality of split suspension cables 23B and a plurality of coupling links 24 coupling the split suspension cables 23B. In FIG. 1, only one coupling link 24 is illustrated. A length of each split suspension cable 23B is shorter than a length of the pump column 3. The multiple split suspension cables 23B are coupled in series by the coupling links 24.

The pump installation apparatus further includes a link operating device 50 configured to operate each coupling link 24 to couple and separate the split suspension cables 23B, a support plate 55 that supports the link operating device 50, and a plate actuator 58 configured to move the support plate 55 between a position directly above the pump column 3 and a retreated position. The link operating device 50 is disposed on the support plate 55, and the support plate 55 is coupled to the plate actuator 58. The plate actuator 58 is capable of moving the link operating device 50 and the support plate 55 together. Furthermore, the link operating device 50 has an actuator 52, such as a linear motor or an air cylinder, and the link operating device 50 is configured to be movable on the support plate 55. Specifically, the link operating device 50 is capable of moving relative to the support plate 55.

The link operating device 50 has an operating pin 51 that protrudes toward the coupling link 24. When the coupling link 24 is operated by this operating pin 51, the coupling link 24 is configured to couple or separate the split suspension cables 23B.

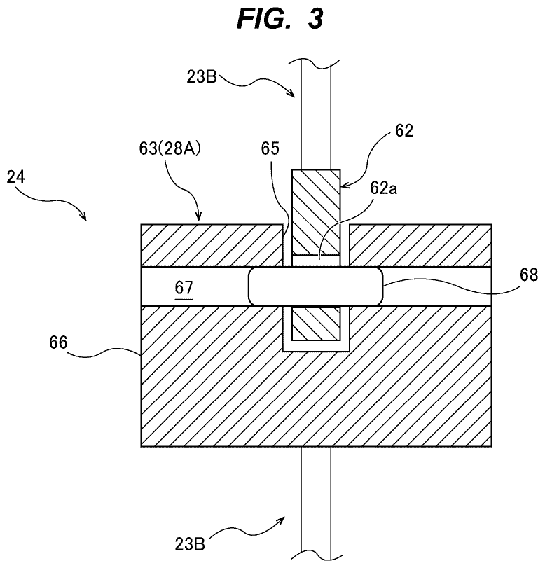

FIG. 3 is a cross-sectional view showing one embodiment of the coupling link 24. As shown in FIG. 3, the coupling link 24 includes a first link mechanism 62 and a second link mechanism 63. The first link mechanism 62 and the second link mechanism 63 are coupled to both ends of each split suspension cable 23B. In the embodiment shown in FIG. 3, the first link mechanism 62 is coupled to a lower end of each split suspension cable 23B, and the second link mechanism 63 is coupled to an upper end of each split suspension cable 23B. The second link mechanism 63 has a width larger than a width of the first link mechanism 62. The link mechanism 28A of the coupling structure 28 shown in FIG. 1 has the same configuration as the second link mechanism 63, and the following description is applied to the link mechanism 28A of the coupling structure 28 as well.

The first link mechanism 62 has a first horizontal hole 62a extending horizontally. The second link mechanism 63 includes a housing 66 having a recess 65 in which the first link mechanism 62 is housed, and a coupling pin 68 disposed in a second horizontal hole 67 formed in the housing 66. The coupling pin 68 is movable within the second horizontal hole 67. The second horizontal hole 67 extends through the housing 66 in the horizontal direction. A diameter of the first horizontal hole 62a of the first link mechanism 62 is larger than a diameter of the coupling pin 68, so that the coupling pin 68 can pass through the first horizontal hole 62a of the first link mechanism 62.

As shown in FIG. 3, when the coupling pin 68 is disposed across the first horizontal hole 62a of the first link mechanism 62, the first link mechanism 62 and the second link mechanism 63 are coupled to each other. On the other hand, when the coupling pin 68 is outside the first horizontal hole 62a of the first link mechanism 62, the first link mechanism 62 is separated from the second link mechanism 63.

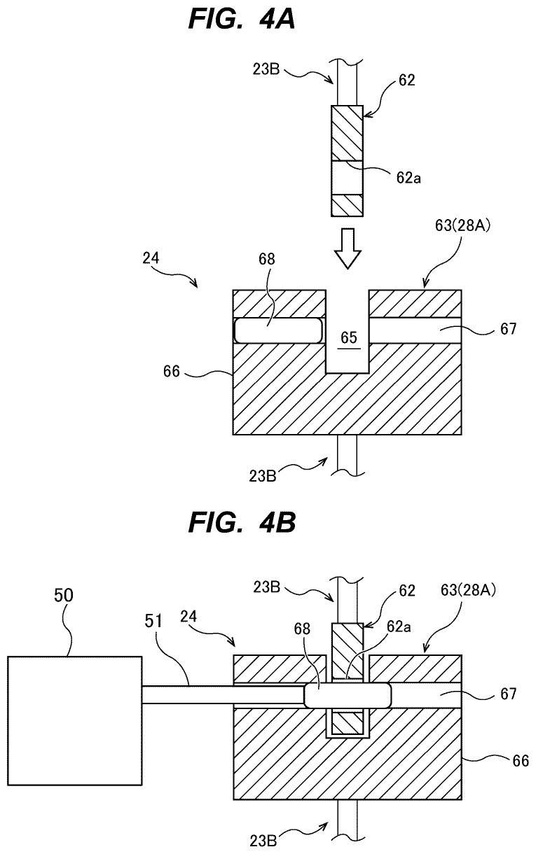

FIGS. 4A and 4B are diagrams for explaining a manner in which the first link mechanism 62 is coupled to the second link mechanism 63 by the link operating device 50. As shown in FIG. 4A, when the coupling pin 68 is located outside the recess 65, the first link mechanism 62 enters the recess 65 of the second link mechanism 63. In a state in which the first horizontal hole 62a of the first link mechanism 62 is aligned with the second horizontal hole 67 of the second link mechanism 63, the link operating device 50 moves toward the second link mechanism 63 of the coupling link 24, until the operation pin 51 of the link operating device 50 pushes the coupling pin 68 into the first horizontal hole 62a, as shown in FIG. 4B. The coupling pin 68 moves into the first horizontal hole 62a, so that the first link mechanism 62 and the second link mechanism 63 are coupled to each other.

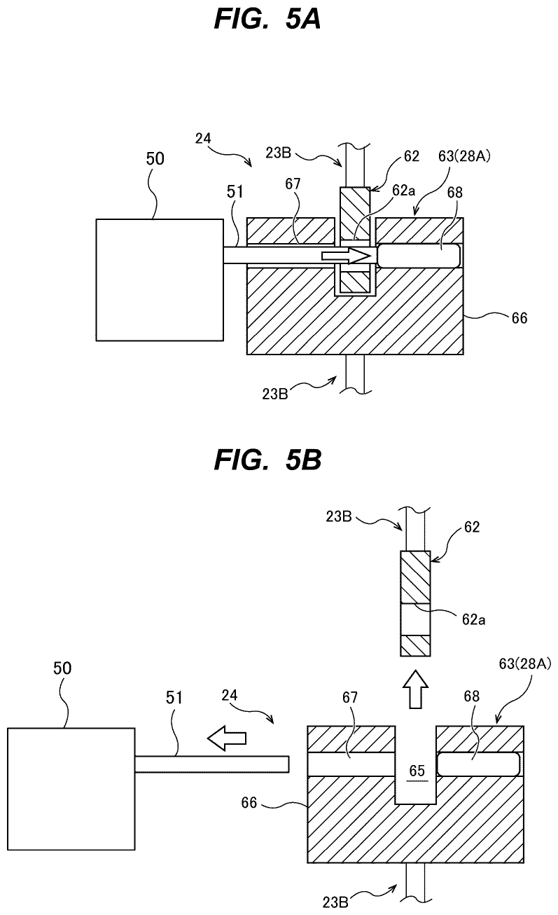

FIGS. 5A and 5B are diagrams illustrating a manner in which the first link mechanism 62 is separated from the second link mechanism 63 by the link operating device 50. As shown in FIG. 5A, the link operating device 50 moves toward the second link mechanism 63 of the coupling link 24, until the operation pin 51 of the link operating device 50 pushes the coupling pin 68 out of the first horizontal hole 62a. Then, as shown in FIG. 5B, the operation pin 51 of the link operating device 50 is pulled out of the first horizontal hole 62a and the second horizontal hole 67, so that the first link mechanism 62 is separated from the second link mechanism 63.

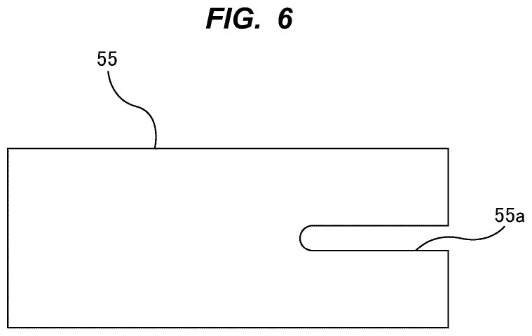

FIG. 6 is a top view showing one embodiment of the support plate 55 shown in FIG. 1. The support plate 55 has a horizontally elongated cut 55a. A width of this cut 55a is larger than the width of the split suspension cable 23B and the width of the coupling member 28B of the coupling structure 28, and is smaller than the width of the second link mechanism 63 of the coupling link 24 and the width of the link mechanism 28A of the coupling structure 28. Therefore, the split suspension cable 23B and the coupling member 28B of the coupling structure 28 can pass through the cut 55a, while the second link mechanism 63 of the coupling link 24 and the link mechanism 28A of the coupling structure 28 cannot pass through the cut 55a.

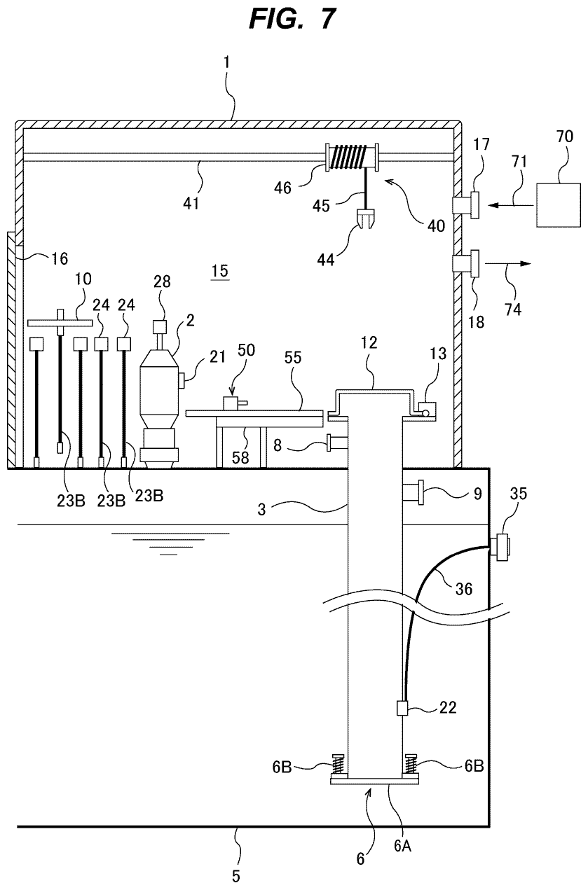

FIG. 7 is a diagram showing a state before the suspension cable 23 and the submersible pump 2 are carried into the pump column 3. As shown in FIG. 7, the multiple split suspension cables 23B constituting the suspension cable 23 and the submersible pump 2 are disposed in a location away from the pump column 3 in the working space 15 of the working chamber 1. The coupling structure 28 and the first electrical contact 21 are attached in advance to the submersible pump 2. The coupling link 24 is attached in advance to each split suspension cable 23B, and the head plate 10 is attached in advance to one split suspension cable 23B. The valve element 6A of the suction valve 6 is pressed against the lower end of the pump column 3 by the multiple springs 6B to close the lower opening of the pump column 3.

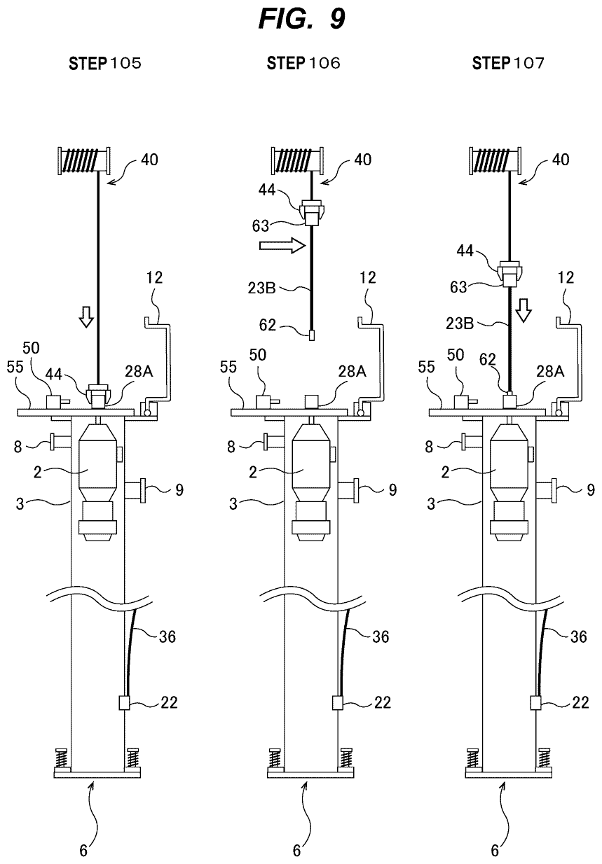

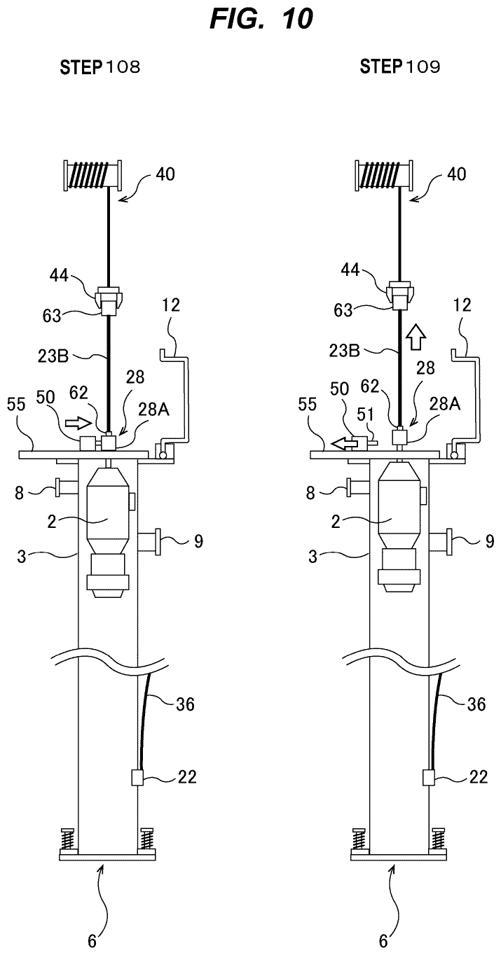

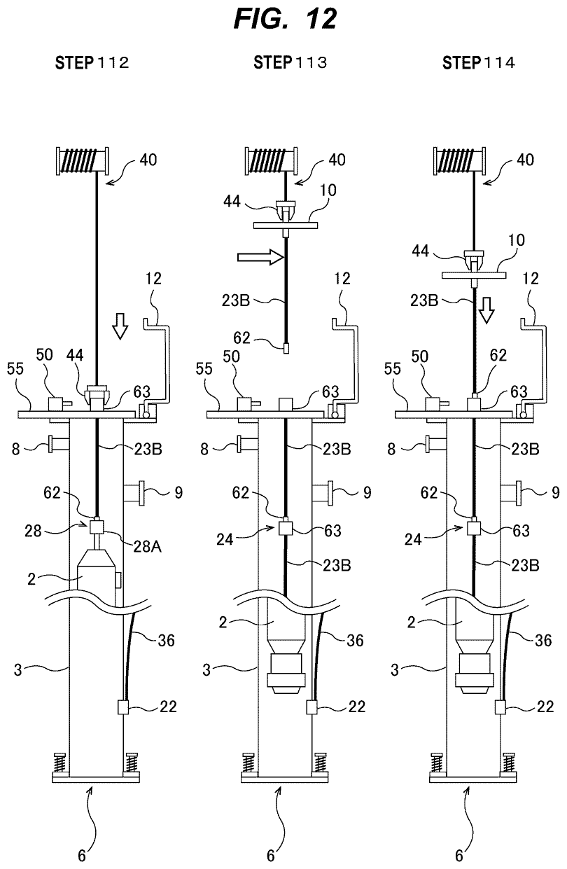

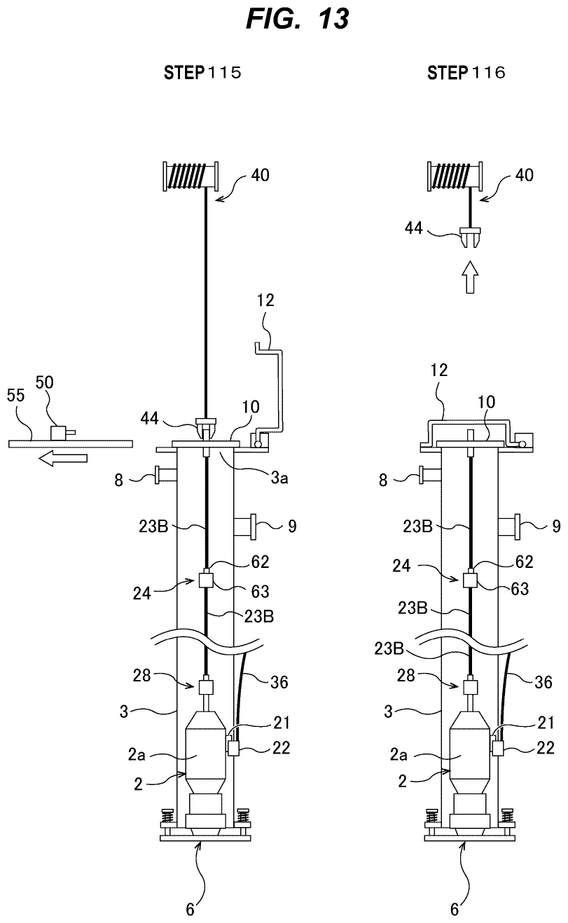

Next, one embodiment of a method of installing the submersible pump 2 in the pump column 3 will be described with reference to FIGS. 7 to 13. A series of operations shown in FIGS. 7 to 13 includes an operation of lowering the submersible pump 2 in the pump column 3 and an operation of adding the multiple split suspension cables 23B to the suspension cable 23 one by one. Before the operations described below, the liquefied gas is discharged from the pump column 3. Specifically, with the actuator-driven door 12 open, the purge gas is supplied into the working space 15 through the purge-gas inlet port 17 to increase the pressure in the pump column 3, thereby discharging the liquefied gas from the pump column 3 through the suction valve 6. Then, the actuator-driven door 12 is closed.

In step 101, as shown in FIG. 7, with the upper opening 3a of the pump column 3 closed by the actuator-driven door 12, the working space 15 in the working chamber 1 housing the submersible pump 2 therein is evacuated through the gas outlet port 18. Then, the purge gas (e.g., an inert gas and/or a gas having the same components as the liquefied gas) is supplied from the purge-gas inlet port 17 to the working space 15, until the working space 15 is filled with the purge gas. The submersible pump 2 is exposed to (or contacts) the purge gas in the working space 15, so that air and moisture are removed from the surface of the submersible pump 2. This process is a drying-up process that expels air and moisture from the submersible pump 2. The vacuum evacuation of the working space 15 and the supply of the purge gas to the working space 15 may be repeated.

In step 102, the actuator-driven door 12 is opened, and the submersible pump 2 is transported by the crane 40 to a position over the pump column 3. More specifically, the gripping mechanism 44 of the crane 40 grips the link mechanism 28A of the coupling structure 28 that has been coupled to the submersible pump 2, and the crane 40 transports the submersible pump 2 and the coupling structure 28 together to a position over the pump column 3.

In step 103, the submersible pump 2 and the coupling structure 28 are lowered together by the crane 40, until the submersible pump 2 is moved into the pump column 3 while the link mechanism 28A of the coupling structure 28 is located above the pump column 3.

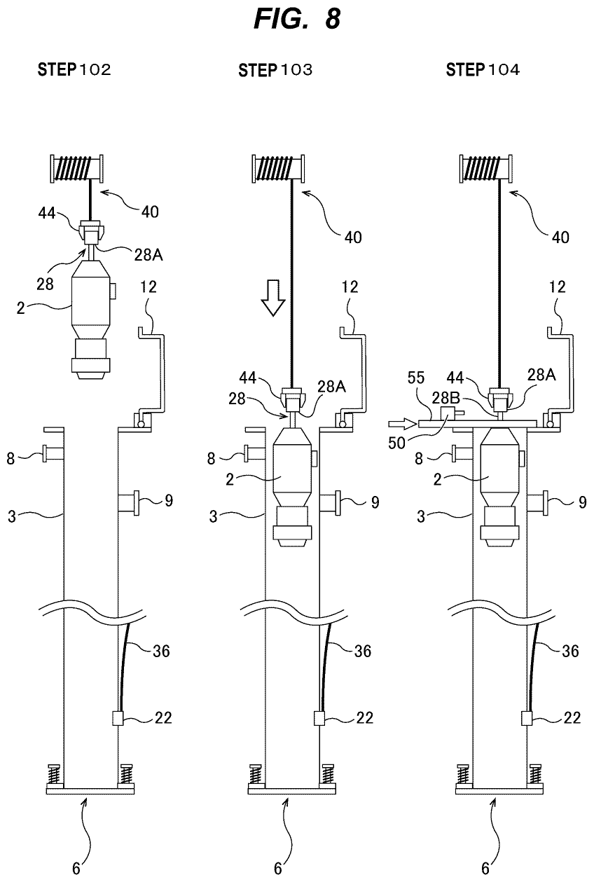

In step 104, with the link mechanism 28A of the coupling structure 28 located above the pump column 3, the plate actuator 58 (see FIG. 1) moves the support plate 55 and the link operating device 50 toward the pump column 3, so that the support plate 55 covers the upper opening 3a of the pump column 3. As described with reference to FIG. 6, the support plate 55 has the cut 55a, and the width of the cut 55a is larger than the width of the coupling member 28B of the coupling structure 28 and smaller than the width of the link mechanism 28A. In the step 104 shown in FIG. 8, the support plate 55 moves onto the pump column 3 so that the coupling member 28B is positioned within the cut 55a of the support plate 55.

In step 105, the crane 40 further lowers the coupling structure 28 and the submersible pump 2 until the link mechanism 28A of the coupling structure 28 comes into contact with the support plate 55. The submersible pump 2 is suspended from the support plate 55 by the coupling structure 28. Specifically, the load of the submersible pump 2 is supported by the support plate 55.

In step 106, the gripping mechanism 44 of the crane 40 releases the link mechanism 28A of the coupling structure 28, and then the crane 40 transports one of the multiple split suspension cables 23B (see FIG. 7) that have been prepared in advance to a position above the pump column 3. The second link mechanism 63 of the coupling link 24 is attached in advance to the upper end of the split suspension cable 23B, and the first link mechanism 62 of the coupling link 24 is attached in advance to the lower end of the split suspension cable 23B.

In step 107, the split suspension cable 23B is lowered by the crane 40 until the first link mechanism 62 attached to the lower end of the split suspension cable 23B enters the recess 65 (see FIG. 4A) of the link mechanism 28A on the support plate 55.

In step 108, the link operating device 50 moves toward the link mechanism 28A on the support plate 55, and the operating pin 51 of the link operating device 50 moves the coupling pin 68 of the link mechanism 28A into the first horizontal hole 62a (see FIG. 4B). As a result, the first link mechanism 62 is coupled to the link mechanism 28A, and the split suspension cable 23B is coupled to the coupling structure 28.

In step 109, the link operating device 50 moves away from the link mechanism 28A until the operating pin 51 of the link operating device 50 is located outside the link mechanism 28A. The split suspension cable 23B, the coupling structure 28, and the submersible pump 2 are then slightly pulled up by the crane 40. The load of the submersible pump 2 is supported by the crane 40.

In step 110, the support plate 55 and the link operating device 50 are moved away from the pump column 3 by the plate actuator 58 (see FIG. 1). The split suspension cable 23B, the coupling structure 28, and the submersible pump 2 are then lowered by the crane 40, so that the submersible pump 2 is moved in the pump column 3 while the second link mechanism 63 of the coupling link 24 is located above the pump column 3.

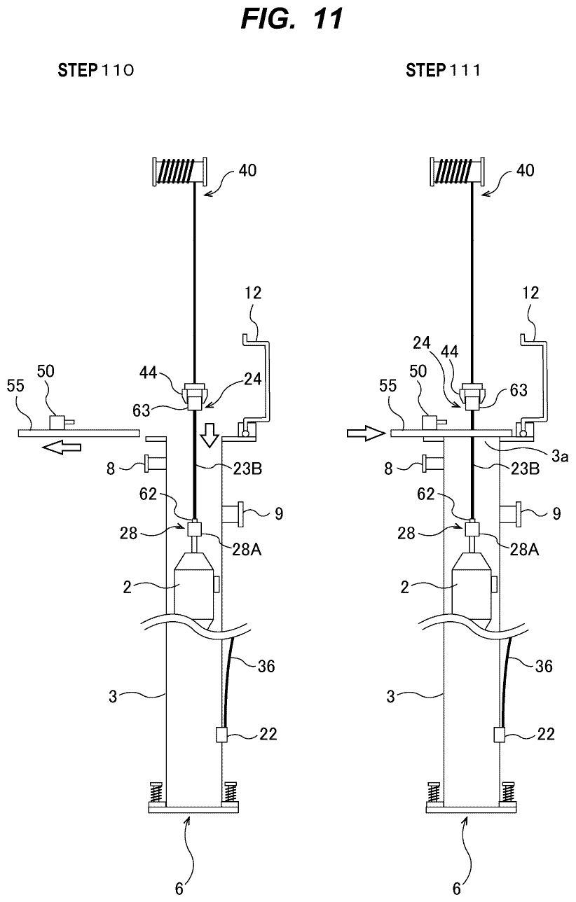

In step 111, before the second link mechanism 63 attached to the uppermost split suspension cable 23B enters the pump column 3, the plate actuator 58 (see FIG. 1) moves the support plate 55 and the link operating device 50 toward the pump column 3 until the support plate 55 covers the upper opening 3a of the pump column 3. As described with reference to FIG. 6, the width of the cut 55a of the support plate 55 is larger than the width of the split suspension cable 23B and smaller than the width of the second link mechanism 63. In the step 111 shown in FIG. 11, the support plate 55 moves onto the pump column 3 so that the split suspension cable 23B is positioned within the cut 55a of the support plate 55.

In step 112, the crane 40 further lowers the split suspension cable 23B, the coupling structure 28, and the submersible pump 2 in the pump column 3 until the second link mechanism 63 attached to the uppermost split suspension cable 23B comes into contact with the support plate 55. The submersible pump 2 is suspended from the support plate 55 by the split suspension cable 23B and the coupling structure 28. In other words, the load of the submersible pump 2 is supported by the support plate 55.

Then, steps similar to those from step 106 to step 112 are repeated while adding the remaining multiple split suspension cables 23B one by one until the submersible pump 2 approaches the bottom of the pump column 3. Specifically, the multiple split suspension cables 23B and the submersible pump 2 are lowered in the pump column 3 by the crane 40 while the multiple split suspension cables 23B are coupled one by one with the coupling links 24 operated by the link operating device 50.

In step 113, when the submersible pump 2 approaches the bottom of the pump column 3, the final split suspension cable 23B is added to the suspension cable 23. The head plate 10 is already coupled to the upper end of this final split suspension cable 23B.

In step 114, as described with reference to FIGS. 4A and 4B, the first link mechanism 62 attached to the lower end of the uppermost split suspension cable 23B is coupled to the second link mechanism 63 on the support plate 55.

In step 115, the plate actuator 58 (see FIG. 1) moves the support plate 55 and the link operating device 50 away from the pump column 3. Next, the crane 40 lowers the split suspension cables 23B, the coupling structure 28, and the submersible pump 2 until the upper opening 3a of the pump column 3 is closed by the head plate 10, and the submersible pump 2 is placed on the suction valve 6. The suction valve 6 opens due to the weight of the submersible pump 2. At the same time, the first electrical contact 21 fixed to the submersible pump 2 comes into contact with the second electrical contact 22 fixed to the pump column 3, thereby establishing an electrical connection between the electric motor 2a of the submersible pump 2 and the power cable 36.

In step 116, the gripping mechanism 44 of the crane 40 is released from the head plate 10, and the actuator-driven door 12 is closed. As a result, the installation of the submersible pump 2 into the pump column 3 is terminated.

A working person can automatically install the submersible pump 2 into the pump column 3 by remotely operating the crane 40, the link operating device 50, and the actuator-driven door 12 from outside the working chamber 1. Therefore, the working person is not exposed to a dangerous atmosphere. In addition, since the upper opening 3a of the pump column 3 is located within the closed working space 15, boil-off gas (BOG) is not discharged to the atmosphere. As a result, an amount of the purge gas used to prevent the discharge of the boil-off gas (BOG) to the atmosphere can be substantially reduced to zero. Furthermore, when the submersible pump 2 is carried into the pump column 3, the working space 15 is filled with the gas having the same components as the liquefied gas, so that the entry of gas containing other components, such as air, into the pump column 3 can be prevented.

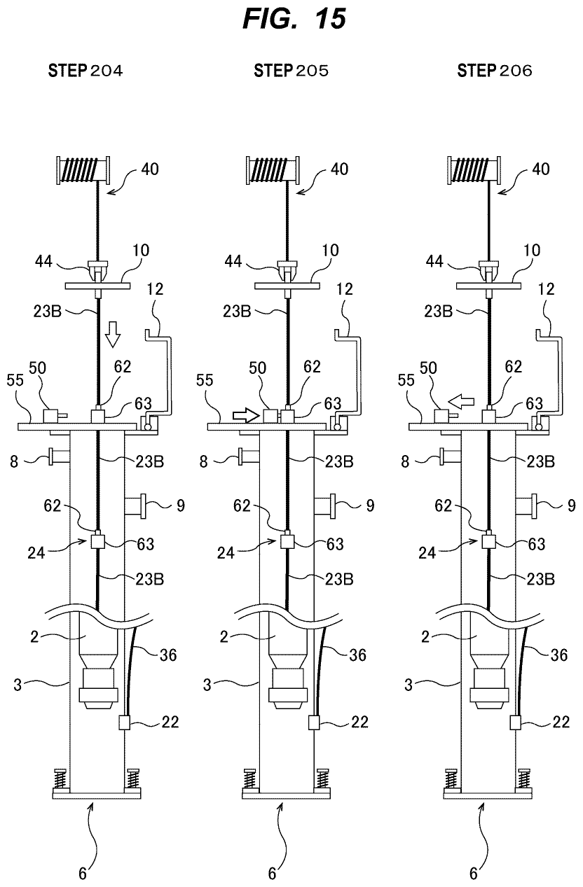

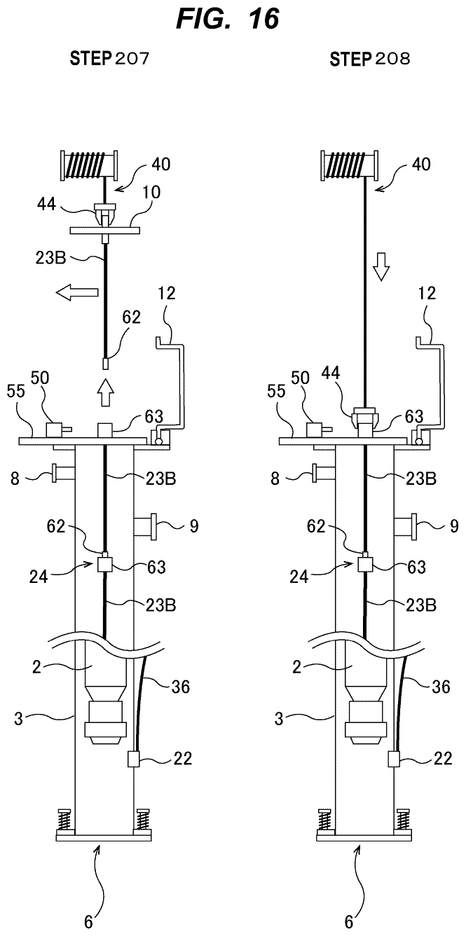

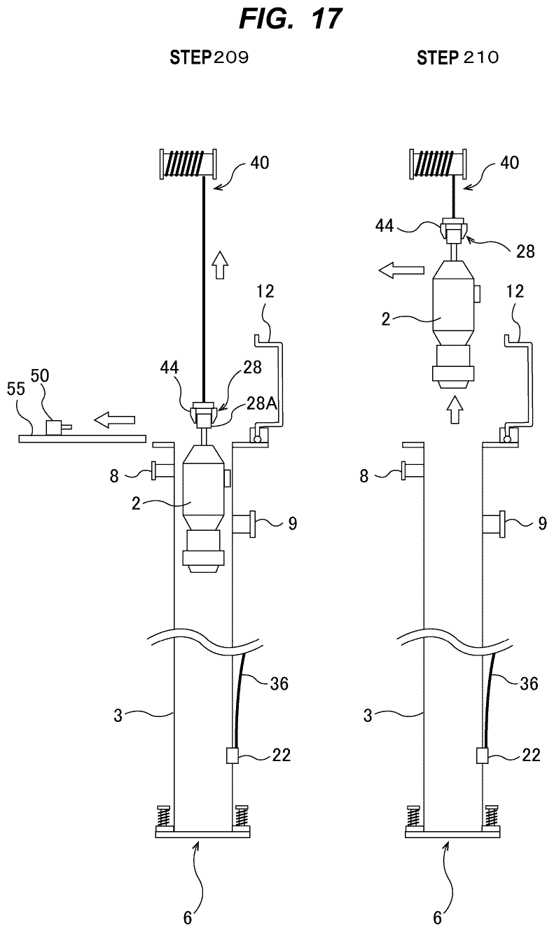

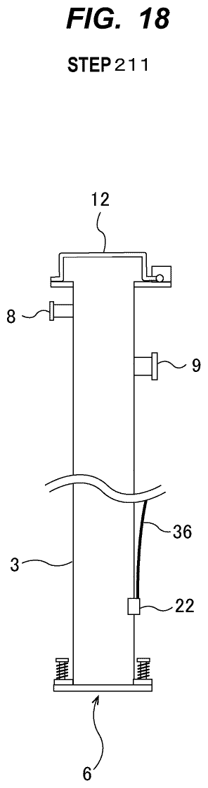

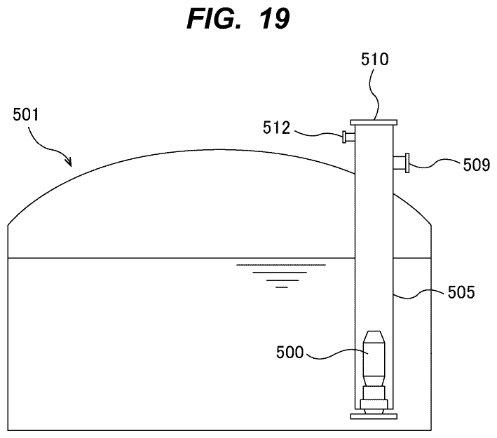

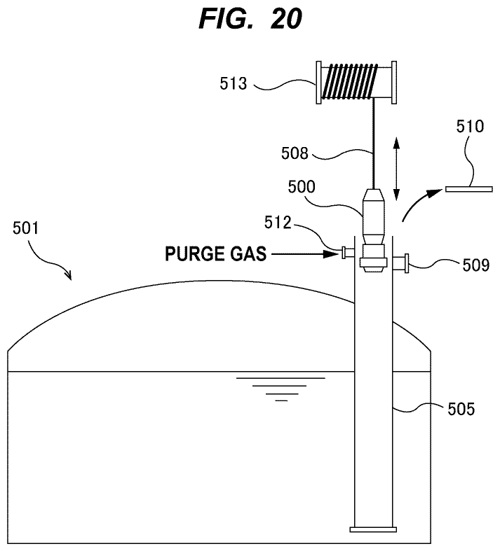

Next, one embodiment of a method of removing the submersible pump 2 from the pump column 3 will be described with reference to FIGS. 1 and 14 to 18. In removing of the submersible pump 2, the steps described with reference to FIGS. 7 to 13 are basically performed in reverse order. A series of operations shown in FIGS. 1 and 14 to 18 includes an operation of raising the submersible pump 2 in the pump column 3 and an operation of removing the multiple split suspension cables 23B from the suspension cables 23 one by one.

In step 201, as shown in FIG. 1, with the upper opening 3a of the pump column 3 closed by the head plate 10 and the actuator-driven door 12, the working space 15 in the working chamber 1 is evacuated through the gas outlet port 18. Then, the purge gas (e.g., an inert gas and/or a gas having the same components as the liquefied gas) is supplied from the purge-gas inlet port 17 into the working space 15 to fill the working space 15. The vacuum evacuation of the working space 15 and the supply of the purge gas to the working space 15 may be repeated.

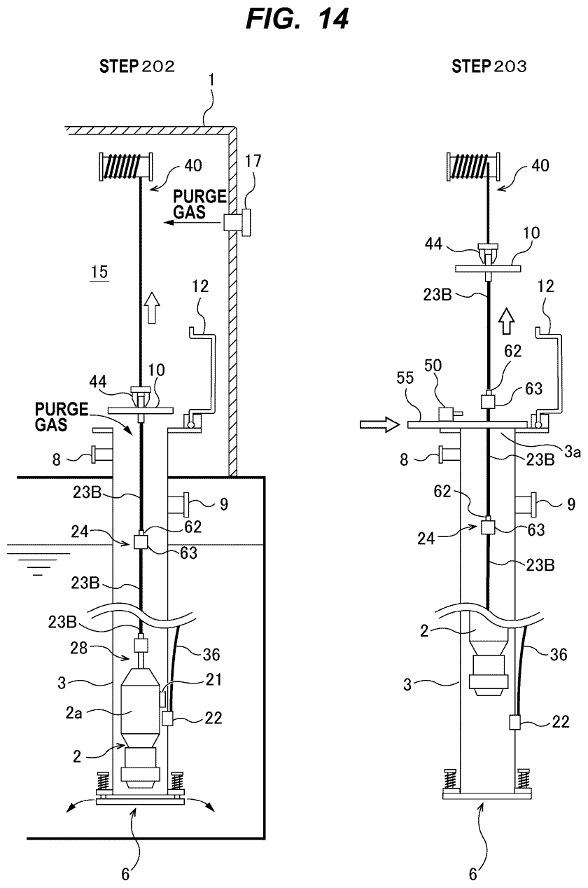

In step 202, as shown in FIG. 14, the actuator-driven door 12 is opened. Next, the head plate 10 is gripped by the gripping mechanism 44 of the crane 40, and the head plate 10, the split suspension cables 23B, the coupling structure 28, and the submersible pump 2 are slightly raised by the crane 40, so that the suction valve 6 is closed. When the submersible pump 2 is raised from its operating position (the position of the submersible pump 2 shown in FIG. 1), the first electrical contact 21 is separated from the second electrical contact 22, thereby cutting off the electrical connection between the electric motor 2a of the submersible pump 2 and the power cable 36. Furthermore, the purge gas is supplied into the working chamber 1 through the purge-gas inlet port 17 to increase the pressure in the pump column 3. As the pressure in the pump column 3 increases, the liquefied gas is discharged from the pump column 3 through the suction valve 6.

In step 203, the multiple split suspension cables 23B, the coupling structure 28, and the submersible pump 2 are pulled up by the crane 40 until the entire uppermost split suspension cable 23B is located above the pump column 3. Thereafter, the support plate 55 and the link operating device 50 are moved toward the pump column 3 by the plate actuator 58 (see FIG. 1) until the upper opening 3a of the pump column 3 is covered by the support plate 55.

In step 204, the crane 40 slightly lowers the split suspension cables 23B, the coupling structure 28, and the submersible pump 2 until the second link mechanism 63 directly above the support plate 55 comes into contact with the support plate 55. The submersible pump 2 is suspended from the support plate 55 by the split suspension cables 23B and the coupling structure 28. In other words, the load of the submersible pump 2 is supported by the support plate 55.

In step 205, the link operating device 50 moves toward the second link mechanism 63 on the support plate 55 until the operating pin 51 of the link operating device 50 moves the coupling pin 68 of the second link mechanism 63 out of the first horizontal hole 62a (see FIG. 5A).

In step 206, the link operating device 50 is moved away from the second link mechanism 63 on the support plate 55 (see FIG. 5B). As a result, the first link mechanism 62 can be separated from the second link mechanism 63, and the uppermost split suspension cable 23B can be separated from the other split suspension cables 23B.

In step 207, the uppermost split suspension cable 23B is pulled up by the crane 40 and then moved to a position away from the pump column 3 (see FIG. 7).

In step 208, the second link mechanism 63 on the support plate 55 is gripped by the crane 40.

Then, steps similar to steps 203 to 207 are repeated while removing the multiple split suspension cables 23B one by one until all of the split suspension cables 23B are removed by the crane 40. Specifically, the multiple split suspension cables 23B and the submersible pump 2 are raised in the pump column 3 by the crane 40 while the coupling links 21 are operated by the link operating device 50 to separate the multiple split suspension cables 23B one by one. When all of the split suspension cables 23B are removed, the link mechanism 28A of the coupling structure 28 attached to the submersible pump 2 is supported by the support plate 55.

In step 209, the link mechanism 28A of the coupling structure 28 is gripped by the gripping mechanism 44, and the coupling structure 28 and the submersible pump 2 are slightly raised by the crane 40. Next, the support plate 55 and the link operating device 50 are moved away from the pump column 3 by the plate actuator 58 (see FIG. 1).

In step 210, the coupling structure 28 and the submersible pump 2 are entirely lifted up from the pump column 3 by the crane 40, and are then transported to a position away from the pump column 3 (see FIG. 7).

In step 211, the actuator-driven door 12 is closed.

As shown in FIG. 7, the purge gas (e.g., an inert gas and/or a gas having the same components as the liquefied gas) is supplied to the working space 15 of the working chamber 1 through the purge-gas inlet port 17 to fill the working space 15 with the purge gas. The submersible pump 2 is exposed to (contacts) the purge gas in the purge container 1, so that the submersible pump 2 is warmed by the purge gas. This is a hot-up process for warming the submersible pump 2. After the hot-up process, the removal of the submersible pump 2 from the pump column 3 is completed.

A working person can automatically remove the submersible pump 2 from the pump column 3 by remotely operating the crane 40, the link operating device 50, and the actuator-driven door 12 from outside the working chamber 1. Therefore, the working person is not exposed to a dangerous atmosphere. In addition, since the upper opening 3a of the pump column 3 is located within the closed working space 15, boil-off gas (BOG) is not released into the atmosphere. As a result, an amount of the purge gas used to prevent the release of boil-off gas (BOG) into the atmosphere can be substantially reduced to zero. Furthermore, when the submersible pump 2 is pulled up from the pump column 3, the working space 15 is filled with a gas having the same components as the liquefied gas, so that the entry of a gas containing other components, such as air, into the pump column 3 can be prevented.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention is applicable to a pump installation apparatus for installing a submersible pump for pressurizing liquefied gas, such as liquefied ammonia, liquefied natural gas (LNG), liquid hydrogen, etc., in a pump column and removing the submersible pump from the pump column. The present invention is further applicable to a method of installing a submersible pump in a pump column using the pump installation apparatus and a method of removing the submersible pump from the pump column using the pump installation apparatus.

### REFERENCE SIGNS LIST

1 working chamber
2 submersible pump
2a electric motor
3 pump column
5 liquified-gas storage tank
6 suction valve
8 purge-gas introduction port
9 discharge port
10 head plate
12 actuator-driven door
13 actuator
15 working space
16 working door
17 purge-gas inlet port
18 gas outlet port
21 first electrical contact
22 second electrical contact
23 suspension cable
23B spit suspension cable
24 coupling link
28 coupling structure
35 electrical contact
36 power cable
40 crane
41 support rail
44 gripping mechanism
45 wire
46 take-up device
50 link operating device
51 operating pin
52 actuator
55 support plate
58 plate actuator
62 first link mechanism
62a first horizontal hole
63 third link mechanism
65 recess
66 housing
67 second horizontal hole
68 coupling pin
70 purge-gas supply source
71 purge-gas supply line
74 vacuum line

What is claimed is:

1. A pump installation apparatus for installing a submersible pump in a pump column and removing the submersible pump from the pump column, the submersible pump being used to deliver liquefied gas, the pump installation apparatus comprising:
a working chamber;
an actuator-driven door covering an upper opening of the pump column; and
a crane configured to transport the suspension cable,
an upper opening of the pump column, the actuator-driven door, and the crane being disposed in the working chamber.

2. The pump installation apparatus according to claim 1, further comprising:
a suspension cable configured to suspend the submersible pump in the pump column,
wherein the suspension cable comprises a plurality of split suspension cables and a plurality of coupling links configured to couple the plurality of split suspension cables, and
the pump installation apparatus further comprises a link operating device configured to operate the plurality of coupling links to cause the plurality of coupling links to couple and separate the plurality of split suspension cables.

3. The pump installation apparatus according to claim 1, wherein the working chamber includes a purge-gas inlet port communicating with the working chamber, and a purge-gas supply line coupled to the purge-gas inlet port.

4. The pump installation apparatus according to claim 1, further comprising:
a first electrical contact electrically coupled to an electric motor of the submersible pump;
a second electrical contact fixed to the pump column and in contact with the first electrical contact; and
a power cable electrically coupled to the second electrical contact.

5. A method of installing a submersible pump in a pump column, the submersible pump being used to deliver liquefied gas, the method comprising:
opening an actuator-driven door disposed within a working chamber, the actuator-driven door being coupled to an upper portion of the pump column; and
lowering the submersible pump in the pump column by a crane disposed in the working chamber, an upper opening of the pump column being located in the working chamber.

6. The method according to claim 5, further comprising:
coupling a suspension cable to the submersible pump within the working chamber before the submersible pump is lowered in the pump column,
wherein the suspension cable has a plurality of split suspension cables and a plurality of coupling links configured to couple the plurality of split suspension cables, and
lowering the submersible pump in the pump column comprises lowering the plurality of split suspension cables and the submersible pump in the pump column by the crane while operating the plurality of coupling links with a link operating device to couple the plurality of split suspension cables one by one.

7. The method according to claim 5, further comprising supplying a purge gas into the working chamber before the submersible pump is carried into the pump column to expose the submersible pump to the purge gas within the working chamber.

8. The method according to claim 5, further comprising bringing a first electrical contact, which is electrically coupled to an electric motor of the submersible pump, into contact with a second electrical contact fixed to the pump column when the submersible pump is lowered in the pump column.

9. A method of removing a submersible pump from a pump column, the submersible pump being used to deliver liquefied gas, the method comprising:
opening an actuator-driven door located in a working chamber, the actuator-driven door being coupled to an upper portion of the pump column;
raising the submersible pump in the pump column by pulling up the submersible pump with a crane, the crane being disposed in the working chamber; and
raising the submersible pump from the pump column into the working chamber by the crane, an upper opening of the pump column being located in the working chamber.

10. The method according to claim 9, wherein
raising the submersible pump in the pump column comprises raising a plurality of split suspension cables and the submersible pump in the pump column with the crane while operating a plurality of coupling links with a link operating device to separate the plurality of split suspension cables one by one, the plurality of coupling links being configured to couple the plurality of split suspension cables.

11. The method according to claim 9, further comprising supplying a purge gas into the working chamber after raising the submersible pump from the pump column into the working chamber to expose the submersible pump to the purge gas within the working space.

12. The method according to claim 9, further comprising separating a first electrical contact, which is electrically coupled to an electric motor of the submersible pump, from a second electrical contact fixed to the pump column when the submersible pump is raised in the pump column.
